(19) United States
(12) Patent Application Publication
(10) Pub. No.: US 2014/0194545 A1
(43) Pub. Date: Jul. 10, 2014

(54) VEHICLE TYRE HAVING A TREAD COMPRISING A HEAT-EXPANDABLE RUBBER COMPOSITION

(71) Applicants: Masayuki Maesaka, Chiyoda-ku (JP); Salvatore Pagano, Clermont-Ferrand Cedex 9 (FR)

(72) Inventors: Masayuki Maesaka, Chiyoda-ku (JP); Salvatore Pagano, Clermont-Ferrand Cedex 9 (FR)

(73) Assignees: MICHELIN RECHERCHE ET TECHNIQUE S.A., GRANGES-PACCOT (CH); COMPAGNIE GENERALE DES ETABLISSEMENTS MICHELIN, CLERMONT-FERRAND (FR)

(21) Appl. No.: 14/122,409

(22) PCT Filed: May 31, 2012
(86) PCT No.: PCT/EP2012/060213

§ 371 Date: Nov. 26, 2013

(30) Foreign Application Priority Data
Jun. 1, 2011 (FR) 1154798

(51) Int. Cl. C08L 9/00

(52) U.S. Cl. CPC C08L 9/00
USPC 521/89

(57) ABSTRACT

A vehicle tyre, usable in winter weather, includes a tread formed of a rubber composition that is heat-expandable when in an unvulcanized state, and expanded when in a vulcanized state. When unvulcanized, the composition includes a diene elastomer, such as natural rubber and/or a polybutadiene; more than 50 phr of a reinforcing filler, such as silica and/or carbon black; between 5 and 25 phr of a sodium- or potassium-including carbonate or hydrogen carbonate; and between 2 and 20 phr of a carboxylic acid having a melting point between 60° C. and 220° C., such as citric acid or stearic acid. A total content of the carboxylic acid and the carbonate or the hydrogen carbonate is greater than 10 phr. Presence of the carboxylic acid and the carbonate or the hydrogen carbonate makes it possible to greatly improve the tyre's grip on melting ice.

### 1. FIELD OF THE INVENTION

The invention relates to rubber compositions used as treads of tyres for vehicles, in particular of “winter” tyres capable of rolling over ground surfaces covered with ice or black ice without being provided with studs (also known as studless tyres).

It relates more particularly to treads of winter tyres specifically suited to rolling under “melting ice” conditions encountered within a temperature range typically of between −5° C. and 0° C. It should specifically be remembered that, within such a range, the pressure of the tyres during the passage of a vehicle brings about surface melting of the ice, which is covered with a thin film of water detrimental to the grip of these tyres.

### 2. PRIOR ART

In order to avoid the harmful effects of the studs, in particular their strong abrasive action on the surfacing of the ground surface itself and a significantly poorer road performance on a dry ground surface, tyre manufacturers have provided various solutions which consist in modifying the formulation of the rubber compositions themselves.

Thus, the proposal has been made, first of all, to incorporate solid particles of high hardness, such as, for example, silicon carbide (see, for example, U.S. Pat. No. 3,878,147), some of which will come to the surface of the tread as the latter wears and thus come into contact with the ice. Such particles, capable of acting, in fact, as micro-studs on hard ice, by virtue of a well-known “claw” effect, remain relatively aggressive with regard to the ground surface; they are not well-suited to rolling conditions on melting ice.

Other solutions have thus been proposed which consist in particular in incorporating water-soluble powders in the constituent composition of the tread. Such powders dissolve more or less on contact with snow or melted ice, which makes possible, on the one hand, the creation at the surface of the tread of porosities capable of improving the grip of the tread on the ground surface and, on the other hand, the creation of grooves which act as channels for discharging the liquid film created between the tyre and the ground surface. Mention may be made, as examples of such water-soluble powders, for example, of the use of cellulose powder, vinyl alcohol powder or starch powder, or else guar gum powders or xanthan gum powders (see, for example, patent applications JP 3-159803, JP 2002-211203, EP 940 435, WO 2008/080750 and WO 2008/080751).

It has also been proposed to use powder particles that are neither of high hardness nor water-soluble, which are nevertheless capable of generating an effective surface microroughness (see in particular patent applications WO 2009/083125 and WO 2009/112220).

Finally, to improve the grip performance of a tread on ice, it is also well known to use a layer of foam rubber based on diene elastomer, a blowing agent and various other additives, such as in particular a blowing activator. These blowing agents, such as for example nitro, sulphonyl or azo compounds, are capable, during a thermal activation, for example during the vulcanization of the tyre, of releasing a large amount of gas, especially nitrogen, and thus of leading to the formation of bubbles within a sufficiently soft material such as a rubber composition comprising such blowing agents. Such foam rubber formulations for winter tyres have been described for example in the patent documents JP 2003-183434, JP 2004-091747, JP 2006-299031, JP 2007-039499, JP 2007-314683, JP2008-001826, JP 2008-150413, EP 826 522, U.S. Pat. No. 5,147,477 and U.S. Pat. No. 6,336,487.

### 3. BRIEF DESCRIPTION OF THE INVENTION

During their research into the above technology relating to the use of foam rubber, the applicants have discovered a specific formulation based on a high content of a blowing agent and a specific activator combined, which makes it possible to greatly improve the grip of treads on melting ice.

Consequently, the present invention relates to a tyre, the tread of which comprises, in the unvulcanized state, a heat-expandable rubber composition comprising at least a diene elastomer, more than 50 phr of a reinforcing filler, between 5 and 25 phr of a sodium or potassium carbonate or hydrogen carbonate, between 2 and 20 phr of a carboxylic acid, the melting point of which is between 60° C. and 220° C., the total content of (hydrogen) carbonate and carboxylic acid being greater than 10 phr.

The invention also relates to a tyre, in the vulcanized state, obtained after curing (vulcanizing) the uncured tyre in accordance with the invention as described above.

The tyres of the invention are particularly intended to equip motor vehicles of passenger type, including 4×4 (four-wheel drive) vehicles and SUV (Sport Utility Vehicles) vehicles, two-wheel vehicles (in particular motorcycles), and also industrial vehicles chosen in particular from vans and heavy-duty vehicles (i.e., underground trains, buses and heavy road transport vehicles, such as lorries or tractors).

The invention and its advantages will be readily understood in the light of the description and the exemplary embodiments that follow.

### 4. DETAILED DESCRIPTION OF THE INVENTION

In the present description, unless expressly indicated otherwise, all the percentages (%) shown are % by weight. The abbreviation “phr” stands for parts by weight per hundred parts of elastomer (of the total of the elastomers if several elastomers are present).

Furthermore, any interval of values denoted by the expression “between a and b” represents the range of values greater than “a” and lower than “b” (that is to say, limits a and b excluded), whereas any interval of values denoted by the expression “from a to b” means the range of values extending from “a” up to “b” (that is to say, including the strict limits a and b).

The tyre of the invention therefore has the essential feature that its tread, in the unvulcanized state, at the very least for its portion (radially outermost part) intended to come directly into contact with the surface of the road, comprises a heat-expandable rubber composition comprising at least:
a (at least one, i.e. one or more) diene elastomer;
more than 50 phr of a (at least one, i.e. one or more) reinforcing filler;
between 5 and 25 phr of a (at least one, i.e. one or more) sodium or potassium carbonate or hydrogen carbonate;
between 2 and 20 phr of a (at least one, i.e. one or more) carboxylic acid, the melting point of which is between 60° C. and 220° C.;
the total content of (hydrogen) carbonate and carboxylic acid being greater than 10 phr.

The various components above are described in detail below.

### 4.1. Diene Elastomer

It should be remembered that elastomer (or rubber, the two terms being synonymous) of the “diene” type should be understood to mean an elastomer resulting at least in part (i.e., a homopolymer or a copolymer) from diene monomers (monomers bearing two conjugated or unconjugated carbon-carbon double bonds).

Diene elastomers can be classified in a known way into two categories: those said to be “essentially unsaturated” and those said to be “essentially saturated”. Butyl rubbers, and also for example diene/α-olefin copolymers of the EPDM type, come within the category of essentially saturated diene elastomers, having a content of units of diene origin which is low or very low, always less than 15% (mol %). In contrast, the expression “essentially unsaturated diene elastomer” is understood to mean a diene elastomer resulting at least in part from conjugated diene monomers, having a content of units of diene origin (conjugated dienes) that is greater than 15% (mol %). In the category of “essentially unsaturated” diene elastomers, the expression “highly unsaturated diene elastomer” is understood to mean in particular a diene elastomer having a content of units of diene origin (conjugated dienes) that is greater than 50%.

It is preferable to use at least one diene elastomer of the highly unsaturated type, in particular a diene elastomer selected from the group consisting of natural rubber (NR), synthetic polyisoprenes (IRs), polybutadienes (BRs), butadiene copolymers, isoprene copolymers and the mixtures of these elastomers. Such copolymers are more preferably selected from the group consisting of butadiene/styrene copolymers (SBRs), isoprene/butadiene copolymers (BIRs), isoprene/styrene copolymers (SIRs), isoprene/butadiene/styrene copolymers (SBIRs) and the mixtures of such copolymers.

The elastomers can, for example, be block, statistical, sequential or microsequential elastomers and can be prepared in dispersion or in solution; they can be coupled and/or star-branched or else functionalized with a coupling and/or star-branching or functionalization agent. Mention may be made, for example, for coupling to carbon black, of functional groups comprising a C—Sn bond or aminated functional groups, such as benzophenone, for example; mention may be made, for example, for coupling to a reinforcing inorganic filler, such as silica, of silanol functional groups or polysiloxane functional groups having a silanol end (such as described, for example, in U.S. Pat. No. 6,013,718), alkoxysilane groups (such as described, for example, in U.S. Pat. No. 5,977,238), carboxyl groups (such as described, for example, in U.S. Pat. No. 6,815,473 or US 2006/0089445) or else polyether groups (such as described, for example, in U.S. Pat. No. 6,503,973). Mention may also be made, as other examples of such functionalized elastomers, of elastomers (such as SBR, BR, NR or IR) of the epoxidized type.

The following are preferably suitable: polybutadienes, in particular those having a content of 1,2-units of between 4% and 80% or those having a content of cis-1,4-units of greater than 80%, polyisoprenes, butadiene/styrene copolymers and in particular those having a styrene content of between 5% and 50% by weight and more particularly between 20% and 40%, a content of 1,2-bonds of the butadiene part of between 4% and 65% and a content of trans-1,4-bonds of between 20% and 80%, butadiene/isoprene copolymers and especially those having an isoprene content of between 5% and 90% by weight and a glass transition temperature (“Tg”, measured according to ASTM D3418-82) from −40° C. to −80° C., or isoprene/styrene copolymers and especially those having a styrene content of between 5% and 50% by weight and a Tg of between −25° C. and −50° C.

In the case of butadiene/styrene/isoprene copolymers, those having a styrene content of between 5% and 50% by weight and more particularly of between 10% and 40%, an isoprene content of between 15% and 60% by weight and more particularly between 20% and 50%, a butadiene content of between 5% and 50% by weight and more particularly of between 20% and 40%, a content of 1,2-units of the butadiene part of between 4% and 85%, a content of trans-1,4-units of the butadiene part of between 6% and 80%, a content of 1,2-plus 3,4-units of the isoprene part of between 5% and 70% and a content of trans-1,4-units of the isoprene part of between 10% and 50%, and more generally any butadiene/styrene/isoprene copolymer having a Tg of between −20° C. and −70° C., are suitable in particular.

According to a particularly preferred embodiment of the invention, the diene elastomer is selected from the group consisting of natural rubber, synthetic polyisoprenes, polybutadienes having a content of cis-1,4-bonds of greater than 90%, butadiene/styrene copolymers and the mixtures of these elastomers.

According to a more particular and preferred embodiment, the heat-expandable rubber composition comprises from 50 to 100 phr of natural rubber or of synthetic polyisoprene, it being possible for said natural rubber or synthetic polyisoprene to be used in particular as a blend (mixture) with at most 50 phr of a polybutadiene having a content of cis-1,4-bonds of greater than 90%.

According to another particular and preferred embodiment, the heat-expandable rubber composition comprises from 50 to 100 phr of a polybutadiene having a content of cis-1,4-bonds of greater than 90%, it being possible for said polybutadiene to be used in particular as a blend with at most 50 phr of natural rubber or synthetic polyisoprene.

Synthetic elastomers other than diene elastomers, or even polymers other than elastomers, for example thermoplastic polymers, may be combined, in a minority amount, with the diene elastomers of the treads according to the invention.

### 4.2. Filler

Use may be made of any filler known for its capabilities in reinforcing a rubber composition, for example an organic filler, such as carbon black, or also an inorganic filler, such as silica, with which is combined, in a known way, a coupling agent.

Such a filler preferably consists of nanoparticles, the (weight-)average size of which is less than a micrometre, generally less than 500 nm, usually between 20 and 200 nm, in particular and more preferably between 20 and 150 nm.

Preferably, the content of total reinforcing filler (especially silica or carbon black or a mixture of silica and carbon black) is between 50 and 150 phr. A content of greater than or equal to 50 phr promotes good mechanical strength; beyond 150 phr, there exists a risk of excessive stiffness of the rubber composition. For these reasons, the content of total reinforcing filler is more preferably within a range from 70 to 120 phr.

Suitable as carbon blacks are, for example, all carbon blacks which are conventionally used in tyres (“tyre-grade” blacks), such as carbon blacks of the 100, 200 or 300 series (ASTM grades), such as, for example, the N115, N134, N234, N326, N330, N339, N347 or N375 blacks. The carbon blacks might, for example, be already incorporated in the diene elastomer, in particular isoprene elastomer, in the form of a masterbatch (see, for example, Applications WO 97/36724 or WO 99/16600).

Mention may be made, as examples of organic fillers other than carbon blacks, of functionalized polyvinyl organic fillers, such as described in Applications WO-A-2006/069792, WO-A-2006/069793, WO-A-2008/003434 and WO-A-2008/003435.

“Reinforcing inorganic filler” should be understood here as meaning any inorganic or mineral filler, whatever its colour and its origin (natural or synthetic), also known as “white filler”, “clear filler” or even “non-black filler”, in contrast to carbon black, capable of reinforcing by itself alone, without means other than an intermediate coupling agent, a rubber composition intended for the manufacture of tyres, in other words capable of replacing, in its reinforcing role, a conventional tyre-grade carbon black; such a filler is generally characterized, in a known way, by the presence of hydroxyl (—OH) groups at its surface.

Mineral fillers of the siliceous type, especially silica (SiO₂), are suitable in particular as reinforcing inorganic fillers. The silica used can be any reinforcing silica known to a person skilled in the art, in particular any precipitated or fumed silica exhibiting a BET surface area and a CTAB specific surface area both of less than 450 m²/g, preferably from 30 to 400 m²/g, in particular between 60 and 300 m²/g. Mention will be made, as highly dispersible precipitated silicas (HDSs), for example, of the Ultrasil 7000 and Ultrasil 7005 silicas from Degussa, the Zeosil 1165MP, 1135MP and 1115MP silicas from Rhodia, the Hi-Sil EZ150G silica from PPG or the Zeopol 8715, 8745 and 8755 silicas from Huber.

According to another particularly preferred embodiment, use is made, as predominant filler, of a reinforcing inorganic filler, in particular silica, at a content within a range from 70 to 120 phr, to which reinforcing inorganic filler can advantageously be added carbon black at a minor content at most equal to 15 phr, in particular within a range from 1 to 10 phr.

In order to couple the reinforcing inorganic filler to the diene elastomer, use is made, in a known way, of an at least bifunctional coupling agent (or bonding agent) intended to provide a satisfactory connection, of chemical and/or physical nature, between the inorganic filler (surface of its particles) and the diene elastomer. Use is made in particular of at least bifunctional organosilanes or polyorganosiloxanes.

Use is made in particular of silane polysulphides, referred to as “symmetrical” or “unsymmetrical” depending on their specific structure, such as described, for example, in Applications WO 03/002648 (or US 2005/016651) and WO 03/002649 (or US 2005/016650).

Particularly suitable, without the definition below being limiting, are silane polysulphides corresponding to the following general formula (I):

Z-A-Sₓ-A-Z, (I)

in which:
x is an integer from 2 to 8 (preferably from 2 to 5);
the A symbols, which are identical or different, represent a divalent hydrocarbon radical (preferably a C₁-C₁₈ alkylene group or a C₆-C₁₂ arylene group, more particularly a C₁-C₁₀; in particular C₁-C₄, alkylene, especially propylene);
the Z symbols, which are identical or different, correspond to one of the three formulae below:

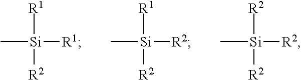

in which:
the R¹ radicals, which are substituted or unsubstituted and identical to or different from one another, represent a C₁-C₁₈ alkyl, C₅-C₁₈ cycloalkyl or C₆-C₁₈ aryl group (preferably C₁-C₆ alkyl, cyclohexyl or phenyl groups, in particular C₁-C₄ alkyl groups, more particularly methyl and/or ethyl);
the R² radicals, which are substituted or unsubstituted and identical to or different from one another, represent a C₁-C₁₈ alkoxyl or C₅-C₁₈ cycloalkoxyl group (preferably a group selected from C₁-C₈ alkoxyls and C₅-C₈ cycloalkoxyls, more preferably still a group selected from C₁-C₄ alkoxyls, in particular methoxyl and ethoxyl).

In the case of a mixture of alkoxysilane polysulphides corresponding to the above formula (I), in particular normal commercially available mixtures, the mean value of the “x” indices is a fractional number preferably of between 2 and 5, more preferably of approximately 4. However, the invention can also advantageously be carried out, for example, with alkoxysilane disulphides (x=2).

Mention will more particularly be made, as examples of silane polysulphides, of bis((C₁-C₄)alkoxyl(C₁-C₄)alkylsilyl(C₁-C₄)alkyl) polysulphides (in particular disulphides, trisulphides or tetrasulphides), such as, for example, bis(3-trimethoxysilylpropyl) or bis(3-triethoxysilylpropyl) polysulphides. Use is in particular made, among these compounds, of bis(3-triethoxysilylpropyl) tetrasulphide, abbreviated to TESPT, of formula [(C₂H₅O)₃Si(CH₂)₃S₂]₂, or bis(triethoxysilylpropyl) disulphide, abbreviated to TESPD, of formula [(C₂H₅O)₃Si(CH₂)₃S]₂. Mention will also be made, as preferred examples, of bis(mono(C₁-C₄)alkoxyldi(C₁-C₄)alkylsilylpropyl) polysulphides (in particular disulphides, trisulphides or tetrasulphides), more particularly bis(monoethoxydimethylsilylpropyl) tetrasulphide, such as described in the abovementioned Patent Application WO 02/083782 (or U.S. Pat. No. 7,217,751).

Mention will in particular be made, as examples of coupling agents other than an alkoxysilane polysulphide, of bifunctional POSs (polyorganosiloxanes), or else of hydroxysilane polysulphides (R²═OH in the above formula I), such as described, for example, in Patent Applications WO 02/30939 (or U.S. Pat. No. 6,774,255), WO 02/31041 (or US 2004/051210) and WO 2007/061550, or else of silanes or POSs bearing azodicarbonyl functional groups, such as described, for example, in Patent Applications WO 2006/125532, WO 2006/125533 and WO 2006/125534.

Mention will be made, as examples of other silane sulphides, for example, of the silanes bearing at least one thiol (—SH) function (referred to as mercaptosilanes) and/or at least one masked thiol function, such as described, for example, in Patents or Patent Applications U.S. Pat. No. 6,849,754, WO 99/09036, WO 2006/023815 and WO 2007/098080.

Of course, use might also be made of mixtures of the coupling agents described above, as described in particular in the abovementioned Application WO 2006/125534.

When they are reinforced with an inorganic filler, such as silica, the rubber compositions preferably comprise between 2 and 15 phr, more preferably between 3 and 12 phr, of coupling agent.

A person skilled in the art will understand that, as filler equivalent to the reinforcing inorganic filler described in the present section, a reinforcing filler of another nature, in particular organic nature, could be used provided that this reinforcing filler is covered with an inorganic layer, such as silica, or else comprises functional sites, in particular hydroxyl sites, at its surface that require the use of a coupling agent in order to form the bond between the filler and the elastomer.

### 4.3. Blowing Agent and Associated Activator

The invention has the essential feature of using, in combination, at particularly high contents, a sodium or potassium carbonate or hydrogen carbonate as blowing agent, and, as blowing activator, a carboxylic acid, the melting point of which is between 60° C. and 220° C.

In a well-known way, a blowing agent is a compound which can decompose thermally and which is intended to release, during thermal activation, for example during the vulcanization of the tyre, a large amount of gas and to thus result in the formation of bubbles. The release of gas in the rubber composition thus originates from this thermal decomposition of the blowing agent.

The blowing agent used in accordance with the present invention is a sodium or potassium carbonate or hydrogen carbonate (also referred to as bicarbonate). In other words, it is selected from the group consisting of sodium carbonate, sodium hydrogen carbonate, potassium carbonate, potassium hydrogen carbonate and the mixtures of such compounds (including, of course, their hydrated forms).

Such a blowing agent has the advantage of only giving off carbon dioxide and water during its decomposition; it is thus particularly favourable to the environment. Use is made in particular of sodium hydrogen carbonate (NaHCO₃).

The content of this blowing agent is between 5 and 25 phr, preferably between 8 and 20 phr.

Another essential feature of the invention is to add, to the blowing agent described above, a carboxylic acid, the melting point of which is between 60° C. and 220° C.

The content of this carboxylic acid is between 2 and 20 phr, preferably between 2 and 15 phr. By dispersing homogeneously in the composition, during its melting within the specific temperature range indicated above, this carboxylic acid has the role of chemically activating (i.e., by chemical reaction) the blowing agent which, during its thermal decomposition, will thus release many more bubbles of gas (CO₂ and H₂O) than if it were used alone.

Any carboxylic acid exhibiting a melting point of between 60° C. and 220° C. (thus solid at 23° C.), preferably between 100° C. and 200° C., in particular between 120° C. and 180° C., is capable of being suitable. The melting point is a well-known basic physical constant (available, for example, in “Handbook of Chemistry and Physics”) of organic or inorganic heat-fusible compounds; it can be monitored by any known method, for example by the Thiele method, the Köfler bench method or else by DSC analysis.

The carboxylic acids can be monoacids, diacids or triacids; they can be aliphatic or aromatic; they can also comprise additional functional groups (other than COOH), such as hydroxyl (OH) groups, ketone (C═O) groups or also groups bearing ethylenic unsaturation.

According to a preferred embodiment, the pKₐ (Kₐ acidity constant) of the carboxylic acid is greater than 1, more preferably between 2.5 and 12, in particular between 3 and 10.

According to another preferred embodiment, in or not in combination with the preceding one, the carboxylic acid comprises, along its hydrocarbon chain, from 2 to 22 carbon atoms, preferably from 4 to 20 carbon atoms.

The aliphatic monoacids preferably comprise, along their hydrocarbon chain, at least 16 carbon atoms; mention may be made, as examples, of palmitic acid (C₁₆), stearic acid (C₁₈), nonadecanoic acid (C₁₉), behenic acid (C₂₀) and various mixtures thereof The aliphatic diacids preferably comprise, along their hydrocarbon chain, from 2 to 10 carbon atoms; mention may be made, as examples, of oxalic acid (C₂), malonic acid (C₃), succinic acid (C₄), glutaric acid (C₅), adipic acid (C₆), pimelic acid (C₇), suberic acid (C₈), azelaic acid (C₉), sebacic acid (C₁₀) and various mixtures thereof Mention may be made, as aromatic monoacid, for example, of benzoic acid. The acids comprising functional groups can be monoacids, diacids or triacids of the aliphatic type and of the aromatic type; mention may be made, as examples, of tartaric acid, malic acid, maleic acid, glycolic acid, a-ketoglutaric acid, salicylic acid, phthalic acid or citric acid.

Preferably, the carboxylic acid is selected from the group consisting of palmitic acid, stearic acid, nonadecanoic acid, behenic acid, oxalic acid, malonic acid, succinic acid, glutaric acid, adipic acid, pimelic acid, suberic acid, azelaic acid, sebacic acid, benzoic acid, tartaric acid, malic acid, maleic acid, glycolic acid, α-ketoglutaric acid, salicylic acid, phthalic acid, citric acid or the mixtures of these acids.

More particularly, the carboxylic acid is selected from the group consisting of malic acid, α-ketoglutaric acid, citric acid, stearic acid and mixtures thereof More preferably still, citric acid, stearic acid or a mixture of these two acids is used.

Another essential feature of the invention, for obtaining an optimized grip of the tread on melting ice, is that the total amount of blowing agent and of its associated activator must be greater than 10 phr, preferably between 10 and 40 phr. This total amount is more preferably greater than 15 phr, in particular between 15 and 40 phr.

### 4.4. Various Additives

The heat-expandable rubber composition can also comprise all or some of the usual additives customarily used in rubber compositions for tyre treads, such as, for example, protective agents, such as antiozone waxes, chemical antiozonants, antioxidants, plasticizing agents, a crosslinking system based either on sulphur or on sulphur donors and/or on peroxide and/or on bismaleimides, vulcanization accelerators or vulcanization activators.

According to a preferred embodiment, the heat-expandable rubber composition also comprises a liquid plasticizing agent (liquid at 20° C.), the role of which is to soften the matrix by diluting the diene elastomer and the reinforcing filler; its Tg (glass transition temperature) is, by definition, less than −20° C., preferably less than −40° C.

More preferably, for an optimum performance of the tyre tread of the invention, this liquid plasticizer is used at a relatively low content, such that the weight ratio of reinforcing filler to liquid plasticizing agent is greater than 2.0, more preferably greater than 2.5, in particular greater than 3.0.

Any extending oil, whether of aromatic or non-aromatic nature, any liquid plasticizing agent known for its plasticizing properties with regard to diene elastomers, can be used. At ambient temperature (20° C.), these plasticizers or these oils, which are more or less viscous, are liquids (that is to say, as a reminder, substances which have the ability to eventually assume the shape of their container), in contrast in particular to plasticizing hydrocarbon resins, which are by nature solids at ambient temperature.

According to one particular embodiment of the invention, the liquid plasticizer is in particular a petroleum oil, preferably a non-aromatic petroleum oil. A liquid plasticizer is described as non-aromatic when it exhibits a content of polycyclic aromatic compounds, determined with the extract in DMSO according to the IP 346 method, of less than 3% by weight, with respect to the total weight of the plasticizer.

Liquid plasticizers selected from the group consisting of naphthenic oils (low- or high-viscosity, in particular hydrogenated or non-hydrogenated), paraffinic oils, MES (Medium Extracted Solvates) oils, DAE (Distillate Aromatic Extract) oils, TDAE (Treated Distillate Aromatic Extract) oils, RAE (Residual Aromatic Extract) oils, TRAE (Treated Residual Aromatic Extract) oils, SRAE (Safety Residual Aromatic Extract) oils, mineral oils, vegetable oils, ether plasticizers, ester plasticizers, phosphate plasticizers, sulphonate plasticizers and the mixtures of these compounds are particularly suitable. According to a more preferred embodiment, the liquid plasticizing agent is selected from the group consisting of MES oils, TDAE oils, naphthenic oils, vegetable oils and the mixtures of these oils.

Mention may be made, as phosphate plasticizers for example, of those that contain between 12 and 30 carbon atoms, for example trioctyl phosphate. Mention may in particular be made, as examples of ester plasticizers, of the compounds selected from the group consisting of trimellitates, pyromellitates, phthalates, 1,2-cyclohexanedicarboxylates, adipates, azelates, sebacates, glycerol triesters and the mixtures of these compounds. Among the above triesters, mention may especially be made of glycerol triesters, preferably consisting predominantly (of more than 50%, more preferably of more than 80% by weight) of an unsaturated C₁₈ fatty acid, i.e. selected from the group consisting of oleic acid, linoleic acid, linolenic acid and mixtures of these acids. More preferably, whether it is of synthetic origin or natural origin (the case for example for sunflower or rapeseed vegetable oils), the fatty acid used consists of more than 50% by weight, more preferably still more than 80% by weight, of oleic acid. Such triesters (trioleates) having a high content of oleic acid are well known; they have been described for example in Application WO 02/088238 as plasticizing agents in tyre treads.

According to another preferred embodiment, the rubber composition of the invention can also comprise, as solid plasticizer (solid at 23° C.), a hydrocarbon resin exhibiting a Tg of greater than +20° C., preferably of greater than +30° C., such as described, for example, in Applications WO 2005/087859, WO 2006/061064 or WO 2007/017060.

Hydrocarbon resins are polymers well-known to a person skilled in the art which are essentially based on carbon and hydrogen and which are thus miscible by nature in diene elastomer compositions, when they are additionally described as “plasticizing”. They can be aliphatic, aromatic or also of the aliphatic/aromatic type, that is to say based on aliphatic and/or aromatic monomers. They can be natural or synthetic, based or not based on petroleum (if such is the case, also known under the name of petroleum resins). They are preferably exclusively of hydrocarbon nature, that is to say that they comprise only carbon and hydrogen atoms.

Preferably, the plasticizing hydrocarbon resin exhibits at least one, more preferably all, of the following characteristics:
a Tg of greater than 20° C. (more preferably between 40° C. and 100° C.);
a number-average molecular weight (Mn) of between 400 and 2000 g/mol (more preferably between 500 and 1500 g/mol);
a polydispersity index (PI) of less than 3, more preferably of less than 2 (as a reminder: PI=Mw/Mn with Mw the weight-average molecular weight).

The Tg of this resin is measured in a known way by DSC (Differential Scanning calorimetry) according to Standard ASTM D3418. The macrostructure (Mw, Mn and PI) of the hydrocarbon resin is determined by steric exclusion chromatography (SEC); solvent tetrahydrofuran; temperature 35° C.; concentration 1 g/l; flow rate 1 ml/min; solution filtered through a filter with a porosity of 0.45 μm before injection; Moore calibration with polystyrene standards; set of 3 Waters columns in series (Styragel HR4E, HR1 and HR0.5); detection by differential refractometer (Waters 2410) and its associated operating software (Waters Empower).

According to a particularly preferred embodiment, the plasticizing hydrocarbon resin is selected from the group consisting of cyclopentadiene (abbreviated to CPD) homopolymer or copolymer resins, dicyclopentadiene (abbreviated to DCPD) homopolymer or copolymer resins, terpene homopolymer or copolymer resins, C₅ fraction homopolymer or copolymer resins, C₉ fraction homopolymer or copolymer resins, α-methylstyrene homopolymer or copolymer resins and the mixtures of these resins. Use is more preferably made, among the above copolymer resins, of those selected from the group consisting of (D)CPD/vinylaromatic copolymer resins, (D)CPD/terpene copolymer resins, (D)CPD/C₅ fraction copolymer resins, (D)CPD/C₉ fraction copolymer resins, terpene/vinylaromatic copolymer resins, terpene/phenol copolymer resins, C₅ fraction/vinylaromatic copolymer resins, C₉ fraction/vinylaromatic copolymer resins and the mixtures of these resins.

The term “terpene” combines here, in a known way, alpha-pinene, beta-pinene and limonene monomers; use is preferably made of a limonene monomer, which compound exists, in a known way, in the form of three possible isomers: L-limonene (laevorotatory enantiomer), D-limonene (dextrorotatory enantiomer) or else dipentene, a racemate of the dextrorotatory and laevorotatory enantiomers. Suitable as vinylaromatic monomers are, for example: styrene, α-methylstyrene, ortho-, meta- or para-methylstyrene, vinyltoluene, para-(tert-butyl)styrene, methoxystyrenes, chlorostyrenes, hydroxystyrenes, vinylmesitylene, divinylbenzene, vinylnaphthalene or any vinylaromatic monomer resulting from a C₉ fraction (or more generally from a C₈ to C₁₀ fraction). Preferably, the vinylaromatic compound is styrene or a vinylaromatic monomer resulting from a C₉ fraction (or more generally from a C₈ to C₁₀ fraction). Preferably, the vinylaromatic compound is the minor monomer, expressed as molar fraction, in the copolymer under consideration.

The content of hydrocarbon resin is preferably between 3 and 60 phr, more preferably between 3 and 40 phr, in particular between 5 and 30 phr.

In the case where it is desired to increase the stiffness of the tread once blown, without, however, reducing the content of liquid plasticizer above, reinforcing resins (e.g., methylene acceptors and donors), such as described, for example, in WO 02/10269 or U.S. Pat. No. 7,199,175, can advantageously be incorporated.

The heat-expandable rubber composition may also contain coupling activators when a coupling agent is used, agents for covering the inorganic filler when an inorganic filler is used, or more generally processing aids capable, in a known manner, owing to an improvement of the dispersion of the filler in the rubber matrix and to a lowering of the viscosity of the compositions, of improving their processability in the uncured state; these agents are, for example, hydrolysable silanes or hydroxysilanes such as alkylalkoxysilanes, polyols, polyethers, amines or hydroxylated or hydrolysable polyorganosiloxanes.

### 4.5. Manufacture of the Compositions

The rubber compositions are manufactured in appropriate mixers, for example using two successive phases of preparation according to a general procedure known to a person skilled in the art: a first phase of thermomechanical working or kneading (sometimes referred to as “non-productive” phase) at high temperature, up to a maximum temperature of between 130° C. and 200° C., preferably between 145° C. and 185° C., during which in particular the blowing activator (carboxylic acid) is incorporated, followed by a second phase of mechanical working (sometimes referred to as “productive” phase) at low temperature, typically below 120° C., for example between 60° C. and 100° C., during which finishing phase the blowing agent and the crosslinking or vulcanization system are incorporated.

A process which can be used for the manufacture of such rubber compositions comprises, for example and preferably, the following stages:
in a mixer, incorporating into the elastomer or into the mixture of elastomers, at least the filler and the carboxylic acid, everything being kneaded thermomechanically, in one or more steps, until a maximum temperature of between 130° C. and 200° C. is reached;
cooling the combined mixture to a temperature of less than 100° C.;
then incorporating the blowing agent (Na or K carbonate or hydrogen carbonate) into the mixture thus obtained and cooled, everything being kneaded thermomechanically until a maximum temperature of less than 100° C. is reached;
subsequently incorporating a crosslinking system;
kneading everything up to a maximum temperature of less than 120° C.;
extruding or calendering the rubber composition thus obtained.

By way of example, all the necessary constituents, the optional supplementary covering agents or processing aids and various other additives, with the exception of the blowing agent and the crosslinking system, are introduced, during the first non-productive phase, into an appropriate mixer, such as a standard internal mixer. After thermomechanical working, dropping and cooling of the mixture thus obtained, the blowing agent, then the vulcanization retarder (if such a compound is used) and, finally, the remainder of the vulcanization system (e.g. sulphur and accelerator), at low temperature, are then incorporated, preferably in this order, generally in an external mixer, such as an open mill; everything is then mixed (productive phase) for a few minutes, for example between 5 and 15 min.

The crosslinking system proper is preferably based on sulphur and on a primary vulcanization accelerator, in particular on an accelerator of the sulphenamide type. Added to this vulcanization system are various known secondary vulcanization accelerators or vulcanization activators, such as zinc oxide, stearic acid, guanidine derivatives (in particular diphenylguanidine), and the like, incorporated during the first non-productive phase and/or during the productive phase. The sulphur content is preferably between 0.5 and 5 phr and the content of the primary accelerator is preferably between 0.5 and 8 phr.

Use may be made, as (primary or secondary) accelerator, of any compound capable of acting as accelerator for the vulcanization of diene elastomers in the presence of sulphur, in particular accelerators of the thiazole type, and also their derivatives, and accelerators of thiuram and zinc dithiocarbamate types. These accelerators are, for example, selected from the group consisting of 2-mercaptobenzothiazyl disulphide (abbreviated to “MBTS”), tetrabenzylthiuram disulphide (“TBZTD”), N-cyclohexyl-2-benzothiazyl sulphenamide (“CBS”), N,N-dicyclohexyl-2-benzothiazyl sulphenamide (“DCBS”), N-(tert-butyl)-2-benzothiazyl sulphenamide (“TBBS”), N-(tert-butyl)-2-benzothiazyl sulphenimide (“TBSI”), zinc dibenzyldithiocarbamate (“ZBEC”) and the mixtures of these compounds.

As the carboxylic acid has, as possible effect, that of reducing the induction period (that is to say, the time necessary at the start of the vulcanization reaction) during the curing of the composition, a vulcanization retarder, which makes it possible to counteract this phenomenon and to thus provide the rubber composition with the time necessary for complete expansion before the vulcanization thereof, can advantageously be used.

The content of this vulcanization retarder is preferably between 0.5 and 10 phr, more preferably between 1 and 5 phr, in particular between 1 and 3 phr.

Vulcanization retarders are well known to a person skilled in the art. Mention may be made, for example, of N-cyclohexylthiophthalimide, sold under the name “Vulkalent G” by Lanxess, N-(trichloromethylthio)benzenesulphonamide, sold under the name “Vulkalent E/C” by Lanxess, or also phthalic anhydride, sold under the name “Vulkalent B/C” by Lanxess. Preferably, N-cyclohexylthiophthalimide (abbreviated to “CTP”) is used.

The final composition thus obtained is subsequently calendered, for example in the form of a sheet or a slab, in particular for laboratory characterization, or else calendered or extruded in the form of a heat-expandable tread.

In the uncured (i.e. unvulcanized) and thus unexpanded state, the density, denoted D₁, of the heat-expandable rubber composition is preferably between 1.100 and 1.400 g/cm³, more preferably within a range from 1.150 to 1.350 g/cm³.

The vulcanization (or curing) is carried out in a known way at a temperature generally of between 130° C. and 200° C., for a sufficient time which can vary, for example, between 5 and 90 min, as a function in particular of the curing temperature, of the vulcanization system adopted and of the kinetics of vulcanization of the composition under consideration.

It is during this vulcanization stage that the blowing agent will release a large amount of gas, to result in the formation of bubbles in the foam rubber composition and finally in its expansion.

In the cured (i.e. vulcanized) state, the density, denoted D₂, of the rubber composition once expanded (i.e. in the foam rubber state) is preferably between 0.700 and 1.000 g/cm³, more preferably within a range from 0.750 to 0.950 g/cm³.

Its degree of expansion by volume, denoted T_{E} (expressed as %), is preferably between 20% and 75%, more preferably within a range from 25% to 60%, this degree of expansion T_{E} being calculated in a known way from the above densities D₁ and D₂, as follows:

T_{E}=[(D₁/D₂)−1]×100.

### 5. EXEMPLARY EMBODIMENTS OF THE INVENTION

The heat-expandable rubber composition described previously can advantageously be used in the treads of winter tyres for any type of vehicle, in particular in tyres for passenger vehicles, as demonstrated in the following tests.

For the requirements of these tests, firstly two rubber compositions (denoted C-0 and C-1) were prepared, the formulations of which are given in Table 1 (contents of the various products expressed in phr). Composition C-0 is the control composition, composition C-1 is that in accordance with the invention, it additionally comprises the blowing agent (sodium hydrogen carbonate) and the associated carboxylic acid (citric acid), and also a vulcanization retarder (CTP). The content of liquid plasticizer was adjusted (greatly reduced) in composition C-1 in order to maintain the stiffness, after curing, at the same level as that of the control composition C-0 (Shore A hardness equal to around 51±1, measured in accordance with the standard ASTM D 2240-86).

The following procedure was used for the manufacture of these compositions: the reinforcing filler, the diene elastomer (NR and BR blend), the carboxylic acid for the C-1 composition and the various other ingredients, with the exception of the vulcanization system and the blowing agent, were successively introduced into an internal mixer, the initial vessel temperature of which was approximately 60° C.; the mixer was thus filled to approximately 70% (% by volume). Thermomechanical working (non-productive phase) was then carried out in a stage of approximately 2 to 4 min, until a maximum “dropping” temperature of approximately 150° C. was reached. The mixture thus obtained was recovered and cooled to approximately 50° C. and then the blowing agent (Na hydrogen carbonate), the vulcanization retarder (CTP), subsequently the sulphenamide accelerator and the sulphur were incorporated on an external mixer (homofinisher) at 30° C., everything being mixed (productive phase) for a few minutes.

The compositions C-0 and C-1 thus prepared, directly usable as treads for passenger vehicle winter tyres, were then vulcanized in a press, and their properties were measured before and after curing (see appended Table 2): for an equivalent Shore hardness, the rubber composition according to invention has, after curing, once in the foam rubber (i.e. expanded) state, a significantly reduced density corresponding to a particularly high degree of expansion by volume of around 30%.

These two compositions were then subjected to a laboratory test consisting in measuring their friction coefficient on ice.

The principle is based on a pad of rubber composition that slides at a given speed (for example equal to 5 km/h) over an ice track (temperature of the ice set at −2° C.) with an imposed load (for example equal to 3 kg/cm²). The forces generated in the direction of travel (Fx) of the pad and perpendicular to the travel (Fz) are measured; the ratio Fx/Fz determines the friction coefficient of the test specimen on ice.

The principle of this test is well known to person skilled in the art (see for example Patent Applications EP 1 052 270, EP 1 505 112 and WO 2010/009850). It makes it possible to evaluate, under representative conditions, the grip on melting ice that would be obtained during a running test on a vehicle equipped with tyres whose tread consists of the same rubber compositions.

The results are expressed in Table 3, a value greater than that of the control composition (C-0), arbitrarily set at 100, indicating an improved result, i.e. an aptitude for a shorter braking distance.

These results from Table 3 clearly demonstrate, for the composition C-1 according to the invention compared with the control composition C-0, a notable increase in the friction coefficient both in the new state and in the partially worn state (deliberately eroded so as to remove a thickness of 1 mm), and therefore an improvement in grip on ice, owing to the combined use of the specific blowing agent and the associated carboxylic acid, at the recommended high contents.

Subsequent to these first tests, other rubber compositions, denoted C-2 and C-3, were prepared which are intended to be used as treads of radial carcass passenger vehicle winter tyres, respectively denoted T-2 (control tyres) and T-3 (tyres in accordance with the invention), with a size of 205/65 R15, these tyres being conventionally manufactured and identical in all respects apart from the constituent rubber compositions of their treads.

The formulations (contents in phr) of these two compositions are given in Table 4; as before, the content of liquid plasticizer was reduced in composition C-3 in order to maintain the stiffness after curing at the same level as that of the control composition C-2. Their properties were measured before and after curing (see appended Table 5): for an equivalent Shore hardness, the rubber composition according to invention has, after curing, once in the foam rubber (i.e. expanded) state, a significantly reduced density corresponding to a particularly high degree of expansion by volume of around 35%.

All the tyres were fitted to the front and the rear of a (Honda Civic) motor vehicle equipped with an anti-lock braking system (ABS system), under nominal inflation pressure, and they were first subjected to rolling on a circuit (of approximately 9000 km), on a dry ground surface, for running in and the beginning of wear.

Next, the new (not run-in) and run-in tyres were subjected to the test of grip on ice as described in the paragraph below, at various temperature conditions.

In this test, the distance necessary to change from 20 to 5 km/h during sudden longitudinal braking (activated ABS) on a track covered with ice is measured. A value greater than that of the control, arbitrarily set at 100, indicates an improved result, that is to say a shorter braking distance.

The results of the running tests are given in Table 6 for new tyres and run-in tyres, in relative units, the base 100 being selected for the control tyres T-2 (as a reminder, a value greater than 100 indicates an improved performance).

It is observed that the braking on melting ice (−3° C.) is significantly improved for the tyres in accordance with the invention (T-3), this being already on the new tyres, since an improvement of 7% is observed. However, it is after running in that the advantage of the invention is particularly visible since the braking is improved by 40% on the same type of ice (at −3° C.).

The results furthermore show that the present invention also remains highly advantageous even at a lower temperature (−7° C.) since the braking is improved by 20% in this second case. Indeed, this is, incidentally, the demonstration that the grip on melting ice is a specific problem which requires very specific solutions.

TABLE 1

| Composition No.: | C-0 | C-1 |
|---|---|---|
| BR (1) | 60 | 60 |
| NR (2) | 40 | 40 |
| Silica (3) | 80 | 80 |
| Coupling agent (4) | 5 | 5 |
| Carbon black (5) | 5 | 5 |
| Blowing agent (6) | — | 12.5 |
| Carboxylic acid (7) | — | 5.5 |
| Liquid plasticizer (8) | 60 | 20 |
| DPG (9) | 1.5 | 1.5 |
| ZnO | 1.2 | 1.2 |
| Stearic acid | 1 | 1 |
| Antiozone wax | 1.5 | 1.5 |
| Antioxidant (10) | 2 | 2 |
| Sulphur | 2 | 2 |
| Accelerator (11) | 1.7 | 1.7 |
| Retarder (12) | — | 1.5 |

(1) BR with 4.3% of 1,2-; 2.7% of trans; 93% of cis-1,4- (Tg = −104° C.);
(2) Natural rubber (peptized);
(3) Silica, Ultrasil 7000 from Degussa, HDS type (BET and CTAB: approximately 160 m²/g);
(4) TESPT coupling agent (Si69 from Degussa);
(5) ASTM grade N234 (Cabot);
(6) Sodium hydrogen carbonate (Cellmic 266 from Sankyo Kasei);
(7) Citric acid (Kanto Kagaku);
(8) MES oil (Catenex SNR from Shell);
(9) Diphenylguanidine (Perkacit DPG from Flexsys);
(10) N-(1,3-Dimethylbutyl)-N-phenyl-para-phenylenediamine (Santoflex 6-PPD from Flexsys);
(11) N-Dicyclohexyl-2-benzothiazolesulphenamide (Santocure CBS from Flexsys);
(12) CTP (N-cyclohexylthiophthalimide; Vulkalent G from Lanxess).

TABLE 2

| Composition tested: | C-0 | C-1 |
|---|---|---|
| Density before curing | 1.14 | 1.21 |
| Density after curing | 1.14 | 0.92 |
| Degree of expansion by volume (%) | 0 | 30 |

TABLE 3

| Composition tested: | C-0 | C-1 |
|---|---|---|
| Friction on ice (−2° C.) ⁽¹⁾ | 100 | 109 |
| Friction on ice (−2° C.) ⁽²⁾ | 100 | 120 |

⁽¹⁾ rubber pad in the new state
⁽²⁾ rubber pad in the partially worn state

TABLE 4

| Composition No.: | C-2 | C-3 |
|---|---|---|
| BR (1) | 60 | 60 |
| MR (2) | 40 | 40 |
| Silica (3) | 80 | 80 |
| Coupling agent (4) | 6.4 | 6.4 |
| Carbon black (5) | 5 | 5 |
| Blowing agent (6) | — | 12.5 |
| Carboxylic acid (7) | — | 7.2 |
| Liquid plasticizer (8) | 55 | 35 |
| DPG (9) | 1.5 | 1.5 |
| ZnO | 1.2 | 1.2 |
| Stearic acid | 1 | 1 |
| Antiozone wax | 1.5 | 1.5 |
| Antioxidant (10) | 2 | 2 |
| Sulphur | 2 | 2 |
| Accelerator (11) | 1.7 | 1.7 |
| Retarder (12) | — | 1.5 |

(1) to (12): idem Table 1

TABLE 5

| Composition tested: | C-2 | C-3 |
|---|---|---|
| Density before curing | 1.14 | 1.18 |
| Density after curing | 1.15 | 0.87 |
| Degree of expansion by volume (%) | 0 | 35 |

TABLE 6

| Tyres tested: | T-2 | T-3 |
|---|---|---|
| Braking on ice (−3° C.) ⁽¹⁾ | 100 | 107 |
| Braking on ice (−3° C.) ⁽²⁾ | 100 | 140 |
| Braking on ice (−7° C.) ⁽¹⁾ | 100 | 104 |
| Braking on ice (−7° C.) ⁽²⁾ | 100 | 123 |

⁽¹⁾ tyres in the new state
⁽²⁾ tyres after running in

1-22. (canceled)

23. A tyre comprising a tread,
wherein the tread, in an unvulcanized state, includes a heat-expandable rubber composition,
wherein the rubber composition includes:
a diene elastomer;
more than 50 phr of a reinforcing filler;
between 5 and 25 phr of a carbonate or a hydrogen carbonate, wherein the carbonate or the hydrogen carbonate includes sodium or potassium; and
between 2 and 20 phr of a carboxylic acid having a melting point between 60° C. and 220° C., and
wherein a total content of the carboxylic acid and the carbonate or the hydrogen carbonate is greater than 10 phr.

24. The tyre according to claim 23, wherein the diene elastomer is selected from a group of elastomers consisting of: natural rubber, synthetic polyisoprenes, polybutadienes, butadiene copolymers, isoprene copolymers, and mixtures thereof.

25. The tyre according to claim 24, wherein the rubber composition includes 50 to 100 phr of a natural rubber or a synthetic polyisoprene.

26. The tyre according to claim 25, wherein the natural rubber or the synthetic polyisoprene is used as a blend with at most 50 phr of a polybutadiene having a content of cis-1,4-bonds of greater than 90%.

27. The tyre according to claim 24, wherein the rubber composition includes 50 to 100 phr of a polybutadiene having a content of cis-1,4-bonds of greater than 90%.

28. The tyre according to claim 27, wherein the polybutadiene is used as a blend with at most 50 phr of a natural rubber or a synthetic polyisoprene.

29. The tyre according to claim 23, wherein the reinforcing filler includes an inorganic filler, carbon black, or a mixture of an inorganic filler and carbon black.

30. The tyre according to claim 23, wherein the reinforcing filler is present at a content of between 50 and 150 phr.

31. The tyre according to claim 23, wherein the rubber composition includes a plasticizing agent that is a liquid at 20° C., the plasticizing agent being present at a content such that a weight ratio of the reinforcing filler to the liquid plasticizing agent is greater than 2.0.

32. The tyre according to claim 23, wherein the carbonate or the hydrogen carbonate is present at a content of between 8 and 20 phr.

33. The tyre according to claim 23, wherein the carboxylic acid is present at a content of between 2 and 15 phr.

34. The tyre according to claim 23, wherein the total content of the carboxylic acid and the carbonate or the hydrogen carbonate is greater than 15 phr.

35. The tyre according to claim 23, wherein the melting point of the carboxylic acid is between 100° C. and 200° C.

36. The tyre according to claim 23, wherein a pKₐ of the carboxylic acid is greater than 1.

37. The tyre according to claim 23, wherein the carboxylic acid includes, along a hydrocarbon chain thereof, from 2 to 22 carbon atoms.

38. The tyre according to claim 37, wherein the carboxylic acid is selected from a group of acids consisting of: palmitic acid, stearic acid, nonadecanoic acid, behenic acid, oxalic acid, malonic acid, succinic acid, glutaric acid, adipic acid, pimelic acid, suberic acid, azelaic acid, sebacic acid, benzoic acid, tartaric acid, malic acid, maleic acid, glycolic acid, α-ketoglutaric acid, salicylic acid, phthalic acid, citric acid, and mixtures thereof.

39. The tyre according to claim 38, wherein the carboxylic acid is selected from a group of acids consisting of: malic acid, α-ketoglutaric acid, citric acid, stearic acid, and mixtures thereof.

40. The tyre according to claim 23, wherein the rubber composition includes a vulcanization retarder.

41. The tyre according to claim 23, wherein a density of the rubber composition, when in the unvulcanized state, is between 1.100 and 1.400 g/cm³.

42. The tyre according to claim 23, wherein the tyre is cured to a vulcanized state in which the rubber composition is expanded.

43. The tyre according to claim 42, wherein a density of the rubber composition, when expanded, is between 0.700 and 1.000 g/cm³.

44. The tyre according to claim 42, wherein a degree of expansion by volume of the rubber composition, when expanded, is between 20% and 75%.
